(19) United States
(12) Patent Application Publication
(10) Pub. No.: US 2013/0125626 A1
(43) Pub. Date: May 23, 2013

(54) LEAK DETECTION APPARATUS, SYSTEM, AND METHOD

(71) Applicant: John L. PRITCHETT, Parker, TX (US)

(72) Inventor: John L. PRITCHETT, Parker, TX (US)

(73) Assignee: John L. PRITCHETT, Parker, TX (US)

(21) Appl. No.: 13/298,743

(22) Filed: Nov. 17, 2011

(51) Int. Cl. G01M 3/08

(52) U.S. Cl. 73/49.1

(57) ABSTRACT

Embodiments of the present invention provide an apparatus and method for detecting leaks in a pipe system. Embodiments of the apparatus include components for detectable gas generation and connection to a pipe system. Embodiments of the method include operating a detectable gas generator that is attached to a pipe system and locating a leak in the pipe system by locating the source of detectable gas from the pipe system.

### FIELD OF THE DISCLOSURE

The disclosure relates to apparatus, systems, and methods for detecting leaks. The disclosure also further relates to the detection of leaks in pipes using identifiable gases, such as smoke.

### BACKGROUND

Pipes may be used in plumbing and gas systems as well as other systems. Pipes may have leaks caused by a number of reasons including defective materials, wear and tear, external damage, and bad connections. In some cases, such leaks may be difficult to locate for a variety of reasons including the location of the leak and the size of the leak.

One existing solution is a attaching a pressurized gas source onto the pipe system to force a gas through the pipe. A user may then look for the expelled gas to determine the location of the leak. However, such systems can be expensive due to the number of components including a pressure generator or source and may be cumbersome to implements in tight spaces. Such systems use gas combustion engines which increase the weight and produce exhaust gases. The weight of such systems prevents their use in certain locations that are difficult to access and/or cannot support the weight. These systems are not used indoors due to the release of exhaust gasses into a building. In addition, the pressure applied to the pipe system adds additional strain to the system that may worsen the existing leak or cause additional defects in the pipe system that may or may not be immediately apparent.

Another existing solution consists of attaching a smoke candle to an opening in the pipe system to allow the smoke to travel through the pipes. Allowing the user to search for the smoke to determine the location of the leak. However, such a device may not be used around some pipe systems due to the potential for dangerous combustion. In addition, when searching for the leak the user may locate the smoke after too much smoke is in the vicinity to pinpoint the location of the leak, which requires returning to the candle to stop the flow of smoke into the pipe while the smoke dissipates from around the leak and restarting the smoke in hopes of pinpointing the location of the leak more specifically than before. Alternatively, such a system may require multiple users to minimize the time consumed by stopping and restarting the smoke candle.

### SUMMARY

This disclosure presents devices that provide a leak detection capability for a pipe system. The disclosure further presents a method of using the leak detection devices for improved leak detection in a pipe system. Embodiments of the disclosed apparatus, system, and method may provide for one or more of the following: improved leak detection capabilities, reduced cost devices, improved safety, improved ease of operation in compact spaces, and minimized risk of harm to the pipe system.

Additional aspects, advantages and features of the present invention are included in the following description of exemplary examples thereof, which description should be taken in conjunction with the accompanying figures, wherein like numerals are used to describe the same feature throughout the figures.

### A BRIEF DESCRIPTION OF THE DRAWINGS

FIG. 1 is a depiction of a first embodiment of the apparatus connected to a first pipe system;

FIG. 2 is a depiction of a second embodiment of the apparatus connected to a second pipe system;

FIG. 3 is a schematic view of an embodiment of the apparatus; and

FIG. 4 is a schematic view of a third embodiment of the apparatus connected to a third pipe system.

### DETAILED DESCRIPTION

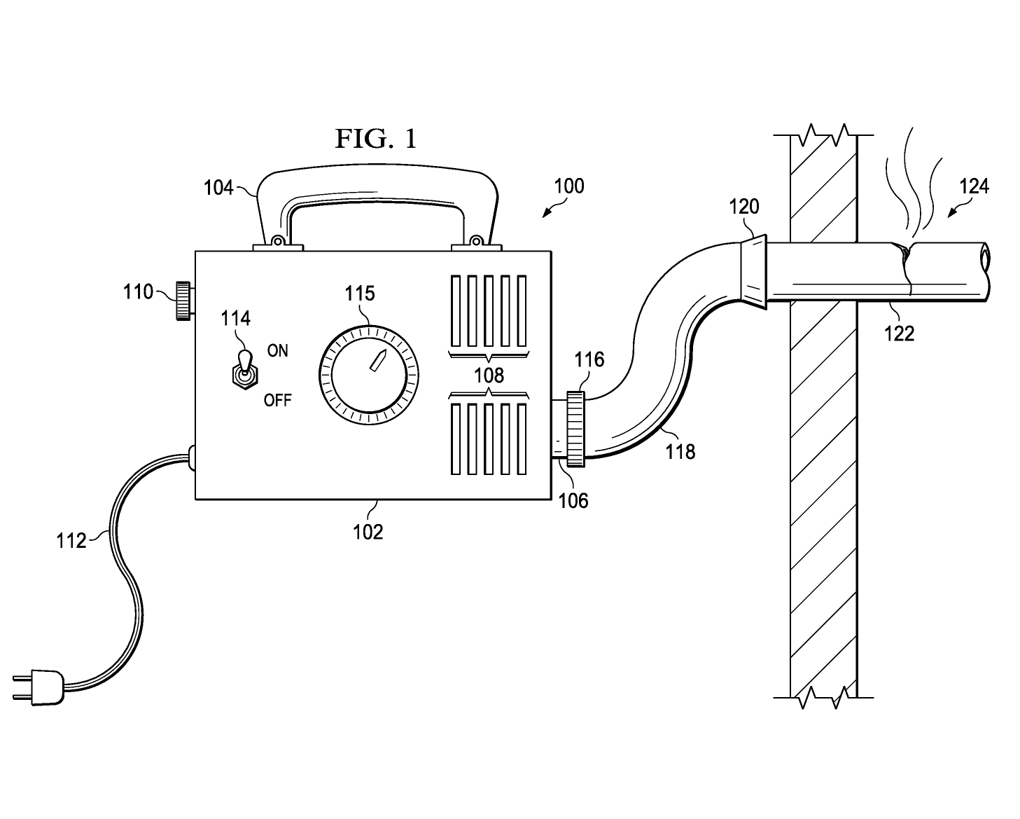

FIG. 1 depicts detectable gas generator 100 attached to pipe system 122. A pipe system may refer to any pipe or set of pipes that may have a leak including but not limited to pipes within a structure, underground pipes, and/or isolated pipes. Detectable gas generator 100 includes housing 102 to provide structural support and protection for internal components (not shown). Housing 102 is connected to handle 104. Handle 104 may be designed in any number of manners that allow a user to carry detectable gas generator 100. In one example, handle 104 is designed to be ergonomic to comfortably fit a user's hand. One skilled in the art will recognize that the design of handle 104 and type of connection to housing 102 may vary and remain within the scope of the disclosure.

Housing 102 includes an output port 106. Internal components (not shown) located within housing 102 provide a source of detectable gas that is output through output port 106. During operation for detecting a leak in pipe system 122, output port 106 is connected to tube 118 by connector 116. Connector 116 may be any connector that will provide a sealed connection to hold tube 118 to output port 106. Tube 118 may be made from rigid or flexible tubing. At the end of tube 118 is pipe connector 120 which provides a sealable connection with an open pipe from pipe system 122. In some embodiments, pipe connector 122 may be one of a group of rigid connectors which is selected by size to match the open pipe size from pipe system 122. In other embodiments, pipe connector 122 is a flexible fitting that can provide a sealed connection with a variety of pipe sizes. One skilled in the art will recognize that pipe connector 122 may vary in size, shape, design, and/or material and remain within the scope and spirit of the present disclosure.

In some embodiments, housing 102 may be designed with compartments, holders, or other attachment mechanisms to hold tube 118 and pipe connector 120 to limit damage or loss of the components when not in use. In some embodiments, housing 102 may be designed with compartments, holders, or other attachment mechanisms to hold alternatives to tube 118 or may hold additional segments of tube 118 which may allow for extension of operable length of tube 118. In some embodiments, housing 102 may be designed with compartments, holders, or other attachment mechanisms to hold alternative pipe connectors 120, such as a selection of sized adapters that match tube 118 on one end and vary in size at the other end for connection to pipe system 122.

Housing 102 also includes vents 108 to exhaust heat from the internal components and improve circulation inside housing 102. Dissipating excess heat from internal components help prevent overheating the system and damaging components of detectable gas generator 100. Vents 108 may be designed in a variety of manners that permit airflow into and out of housing 102 to dissipate heat. Vents 108 may be operationally associated with other heat reducing systems including but not limited to fans, heat sinks, and/or liquid cooling systems.

Housing 102 also includes an input port 110. Input port 110 may be used to provide one or more components for a detectable gas. In some embodiments, input port 110 may be attached to (or part of) a fluid reservoir located within housing 102. In such embodiments, the fluid reservoir may hold liquids that produce smoke when heated.

The depicted embodiment in FIG. 1 includes power cord 112 in order to provide power to detectable gas generator 100 and specifically the internal operational components (not shown). Power may be provided by means other than power cord 112, such as a battery or internal power generator, and remain within the scope and spirit of the present disclosure. Power cord 112 may be retractable into housing 102 to store power cord 112 and prevent or minimize tangling or obstruction by a loose cord. One skilled in the art will recognize that other methods of storing a cord may be used and remain within the scope and spirit of the present disclosure.

Housing 102 also includes switch 114 in this embodiment. Switch 114 may be used to turn detectable gas generator 100 on to begin operation or off to stop the operation. One skilled in the art will recognize that detectable gas generator 100 may include additional or alternative controls for operating the device and for accessory capabilities of the device.

Housing 102 also includes timer 115 in this embodiment. Timer 115 may be utilized in conjunction with switch 114 for additional control over the operation of detectable gas generator 100. For example, timer 115 may be set to delay the release of smoke through output port 106 into pipe system 122 to provide a user time to reach the expected vicinity of the leak 124. In addition, timer 115 may limit the amount of time that smoke is produced to protect internal components and prevent excessive smoke from release through leak 124. In some embodiments, timer 115 may incrementally release and stop the release of smoke so that a user may locate the vicinity of leak 124 while smoke is released, allow the smoke to dissipate while the release is stopped, and pinpoint the location of leak 124 when the smoke is released again.

During use of detectable gas generator 100, a user would prepare an opening to pipe system 122. This may involve removing a cap or plug, separating two adjacent pieces of pipe, or nothing if pipe system 122 has an open pipe included. Detectable gas generator 100 would be placed near the opening of pipe system 122 and set up for operation. One end of tube 118 should be attached to output port 106 using connector 116. The other end of tube 118 should be attached to the opening of pipe system 122 using pipe connector 120. The user should ensure that detectable gas generator 100 includes sufficient components for generation of a detectable gas, and should add any necessary components. For example, if insufficient fluid for smoke generation is in the fluid reservoir (not shown), fluid may be added through input port 110. Detectable gas generator 100 should be attached to a power source via power cord 112.

For operation of detectable gas generator 100, a user may select to set timer 115 for a desired time control operation. For example, the user may set timer 115 to delay releasing smoke for 30 seconds and then release the smoke for 2 minute increments with a 1 minute stop in the release of smoke between release periods. When the user is ready to begin, the user may turn on detectable gas generator 100 using switch 114. During the operation of detectable gas generator 100, the user would search areas around pipe system 122 for detectable smoke. Once the smoke is located, the user would work to determine the precise location of leak 124 in pipe system 122.

For example, a residential plumber may set up detectable gas generator 100 and attach it via tube 118 to a plumbing outlet outside the house. When ready, the plumber may turn on the device and head to the master bathroom where the home owner thinks leak 124 is located and look for smoke. The plumber may wait for signs of smoke and/or search other parts of the house for signs of smoke. Once smoke is located in a room, the plumber would work to pinpoint the location of leak 124 which could be under a sink, behind a wall, or elsewhere. Once leak 124 is pinpointed, detectable gas generator 100 may be turned off at switch 114.

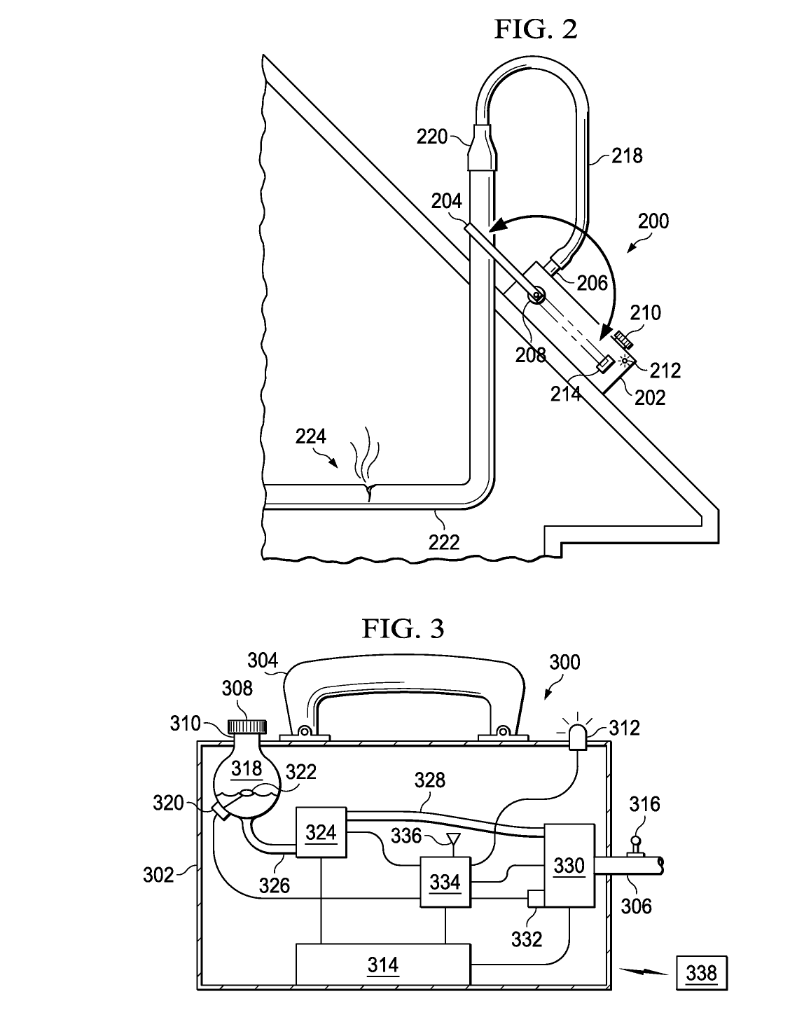

FIG. 2 depicts detectable gas generator 200 illustrating another embodiment of the disclosed device. Detectable gas generator 200 is shown operationally associated with pipe system 222 at a plumbing vent located on the slanted roof of a building. In this embodiment, housing 202 is placed on the roof surface adjacent to the plumbing vent.

Handle 204 is shown extending from housing 202 to the plumbing vent. In this embodiment, handle 204 may be used to hook around the plumbing vent thereby holding housing 202 in place adjacent to the plumbing vent on the slanted roof. As is indicated by arrows next to handle 204 and the alternate position for handle 204, handle 204 is rotatable around first handle attachment 208. One skilled in the art will recognize that the design of handle 204 may be varied and remain within the scope and spirit of the present disclosure. In addition, the adjustable option for handle 204 may be designed differently, such as a slide or extension adjustment, and remain within the scope and spirit of the present disclosure. Handle 204 may be used as shown to assist in securing detectable gas generator 200 in place or rotated into an alternate position for carrying detectable gas generator 200. One skilled in the art will recognize that alternative designs for securing detectable gas generator 200 in place or carrying detectable gas generator 200 may be employed and remain within the scope and spirit of the present disclosure. The alternate position for handle 204 is shown in dotted lines. In the alternate position, the hook end of handle 204 may be secured to second handle attachment 214.

In this embodiment, out put port 206 and input port 210 are located on one side of housing 202 opposite the roof surface. One skilled in the art will recognize that the placement of output port 206 and input port 210 may vary and remain within the scope and spirit of the present disclosure. As described with reference to FIG. 1, the detectable gas exits housing 202 through output port 206 and enters the pipe system 222 via tube 218 which is connected to the plumbing vent by pipe connector 220. In addition, input port 210 is operatively associated with a fluid reservoir to hold fluid associated with the generation of the detectable gas.

In the housing 202 of this embodiment is indicator 212. Indicator 212 is used to indicate the current operational status of detectable gas generator 200. Indicator 212 may be a light-emitting diode (“LED”) or other light source, a display, an audible device, any other sensory device, or a combination of devices. In this embodiment, indicator 212 is shown as an LED. Indicator 212 may indicate different status by changing color, blinking, shutting off, or any combination of visual effects. For an example, indicator 212 may be off when the detectable gas generator is off, it may blink while the device is warming up, and may be on when the device is supplying detectable gas into pipe system 222. In addition, indicator 212 may turn red and blink to indicate an error or warning for a user.

In some embodiments, detectable gas generator 200 will include an automatic shut-off (not shown) that stops the operation of detectable gas generator 200 after a designated amount of time. The designated amount of time may be determined based upon the amount of gas generating fluid in the fluid reservoir. This operates as a safety mechanism to reduce the likelihood that internal components overheat due to a lack of gas generating fluids. One skilled in the art will recognize that other safety components that prevent or reduce the likelihood of potentially damaging operation of detectable gas generator 200 may be included in addition to or as an alternative to the time based shut-off and remain within the scope and spirit of the present disclosure.

A residential plumber may use this embodiment by setting up detectable gas generator 200 and attach it via tube 218 to the vent opening on the roof of a house. When ready, the plumber may turn on the device and watch indicator 212 in order to observe the current operation of detectable gas generator 200. One skilled in the art will recognize that detectable gas generator 200 may be operated through a user interface on the housing 202 or via a remote control that is operatively associated with detectable gas generator 200. Once the device is operating properly, the plumber may head to the master bathroom where the home owner thinks leak 224 is located and look for smoke produced by leak detection device 200. The plumber may wait for signs of smoke and/or search other parts of the house for signs of smoke. Once smoke is located in a room, the plumber would work to pinpoint the location of leak 224 which could be under a sink, behind a wall, or elsewhere. Once leak 224 is pinpointed, detectable gas generator 200 may be turned off using a user control panel on detectable gas generator 200 or a remote user interface.

FIG. 3 depicts a schematic view of an embodiment of a detectable gas generator. FIG. 3 shows detectable gas generator having housing 302 attached to handle 304. Output port extends from heat exchange 330 within housing 302 to outside of housing 302. In this embodiment, output port 306 includes test valve 316 which allows a user to check the gas output through output port 306. Test valve 316 may operate in a variety of manners wherein a user may operate test valve 316 to release gas from output port 306 to determine if detectable gas is passing through output port 306. For example, test valve 316 may consist of a spring loaded valve that may be pulled by a user to release gas and will automatically stop the release of gas through test valve 316 when a user stops pulling the valve.

Input port 310 is located in housing 302 adjacent to handle 304. Input port 310 is shown with cap 308 covering the top of input port 310. Input port 310 may be connected to or part of liquid reservoir 318. In this embodiment, liquid level sensor 320 is attached to liquid reservoir 318 and evaluates the amount of liquid held within liquid reservoir 318 by the level of float 322. One skilled in the art will recognize that liquid level sensor 320 may be any sensor capable of evaluating the liquid level in liquid reservoir 318, including sensors that determine a volume of liquid and/or sensors that determine if the liquid level is below a threshold. For example, liquid level sensor 320 may operate as a switch whereby an electric loop is altered by float 322 falling below a threshold level. In such a case, the alteration of the electric loop may indicate that detectable gas generator 300 should automatically shut-off

Pump 324 is connected to liquid reservoir 318 by input tube 326. During operation, pump 324 pulls the liquid from liquid reservoir 318 through input tube 326 and outputs the liquid through output tube 328. Output tube 328 feeds into heat exchange 330 wherein the liquid is heated into a detectable gas such as smoke. The detectable gas is then released through output port 306.

In this embodiment, battery 314 provides power to pump 324, heat exchange 330, and system control 334. Battery 314 may be removable and replaceable in some embodiments. In some embodiments, battery 314 may be a rechargeable battery. In addition, some embodiments of detectable gas generator 300 may include battery recharging components to allow for recharging of battery 314 by connecting detectable gas generator to an alternative source of power. One skilled in the art will recognize that a variety of power sources and/or combinations of power sources may be used and remain within the scope and spirit of the present disclosure.

In this embodiment, temperature sensor 332 is attached to heat exchange 330. Temperature sensor 332 is monitors the temperature of heat exchange 330 and is operatively associated with system control 334. One skilled in the art will recognize that temperature sensor 332 may be any sensor capable of evaluating the temperature of heat exchange 330, including sensors that determine a actual temperatures and/or sensors that determine if the temperature is above a threshold. For example, temperature sensor 332 may provide signals to system control 334 indicating the temperature of heat exchange 330 whereby system control 334 may automatically shut off detectable gas generator 300 if a temperature threshold is surpassed. One skilled in the art will recognize that system control 334 may operate as any type of automatic shut-off and may be based upon a variety of operational characteristics of the detectable gas generator 300. For example, an automatic shut-off may stop detectable gas generator 300 if a temperature, pressure, liquid level, and/or any safety threshold is met or surpassed.

In this embodiment, system control 334 is operatively associated with battery 314, pump 324, heat exchange 330, indicator 312, liquid level sensor 320, temperature sensor 332, and antenna 336. System control 334 may be any number of control components including computer components, mechanical controls, electronic controls, and/or any combination of components for controlling the system operation. In this embodiment, system control 334 will be discussed as a computer based control system which may include hardware components, such as processors and memory, and software components.

System control 334 controls the output of indicator 312. Indicator 312 operates to indicate the operational status of detectable gas generator 300. As discussed above with regard to FIG. 2, indicator 312 may be any number of devices capable of communicating information to a user through audible, visual, or other sensory outputs. Outputs may include a speaker, a light source, gas alteration source (that can alter characteristics of the detectable gas such as scent or color), and/or a mechanical output. Indicator 312 is shown in this embodiment to be a light emitting device.

This embodiment also includes remote user interface 338 which is shown to communicate wirelessly with detectable gas generator 300. One skilled in the art will recognize that other user interfaces may be employed in conjunction with remote user interface 338 or as an alternative to remote user interface 338 and remain within the scope and spirit of the present disclosure. Remote user interface 338 may be used to operate detectable gas generator 300 by communicating with system control 334 via antenna 336. For example, a person may use remote user interface 338 to turn on and off detectable gas generator 300. In addition, remote user interface 338 may operate as a remote indicator by communicating the status of detectable gas generator 300. The remote indicator may be redundant to indicator 312 in some embodiments, and in other embodiments, the remote indicator may be used instead of indicator 312.

In some embodiments, remote user interface 338 may be another device programmed to communicate with detectable gas generator 300, such as a cellular phone, a tablet, a computer, or another device. For example, a plumber may use a cellular phone equipped with a leak detection application as remote user interface 338. When operating the leak detection application, cellular phone may display in one section control options, such as on, off, pause, and other operational controls, and display indicator information in another section. The indicator information may include the current status of operation for detectable gas generator 300, and/or internal operational information such as fluid volume in fluid reservoir 318 as determined by liquid level sensor 320, the temperature of heat exchange 330 as determined by temperature sensor 332, or the current charge of battery 314.

Following set-up of detectable gas generator 300 with a pipe system (not shown), the operation of detectable gas generator 300 may be initiated through remote user interface 338. The user of detectable gas generator 300 may go to the suspected location of the leak and then use remote user interface 338 to start detectable gas generator 300. If detectable gas is observed, the user may use remote user interface 338 to pause the release of the detectable gas in order to let the gas dissipate prior to recommencing the release of detectable gas in order to pinpoint the location of the leak. Once the leak is pinpointed, a user may shut off detectable gas generator 300 with remote user interface 338. If detectable gas is not observed after a reasonable amount of time following the start of detectable gas generator 300, the user may return to detectable gas generator 300 and use test valve 316 to confirm that detectable gas generator 300 is producing detectable gas.

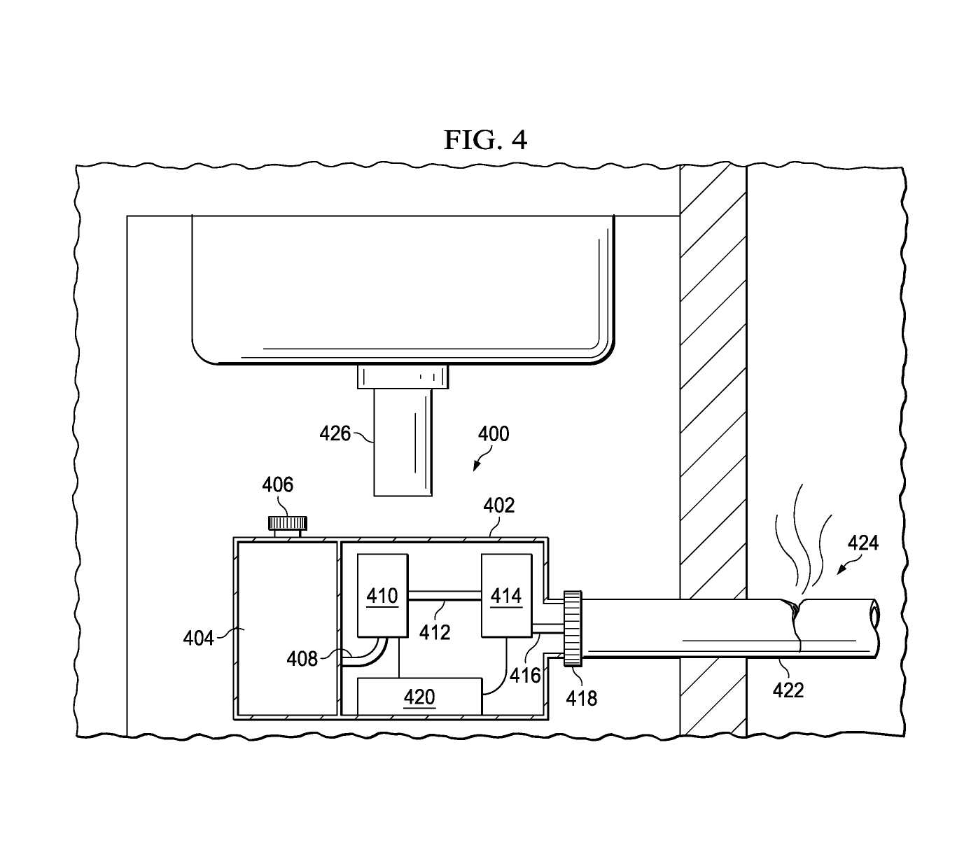

FIG. 4 depicts detectable gas generator 400 which is another embodiment of the present disclosure. In this embodiment, detectable gas generator 400 is a compact design for direct attachment to pipe system 422. The design of this embodiment is restricted such that the size, shape and weight of detectable gas generator 400 does not cause undue or harmful strain on pipe system 422. Detectable gas generator 400 includes housing 402 which contains components for detectable gas production. In some embodiments, housing 402 is ventilated to increase airflow to dissipate heat from the internal components of detectable gas generator 400.

At one end of detectable gas generator 400 is fluid reservoir 404 having input port 406. Fluid reservoir 404 may be contained inside housing 402, attached to housing 402, or formed as part of housing 402. Fluid reservoir 404 is attached to pump 410 by input tube 408. Pump 410 is connected to heat exchange 414 by output tube 412. During operation, liquid from fluid reservoir 404 is pulled through input tube 408 into pump 410 and pushed through output tube 412 into heat exchange 414. In heat exchange 414 the liquid is heated converting it into a detectable gas such as smoke. The detectable gas is then released through output port 416.

Detectable gas generator 400 also includes pipe connection 418 to connect detectable gas generator 400 directly to pipe system 422. Pipe connection 418 may be any type of connection that may connect detectable gas generator 400 directly to pipe system 422, such as an adjustable fitting, a clamped fitting, a threaded gasket, or a friction fitting. In this embodiment, pipe connection 418 can support housing 402 when connected to pipe system 422 due to the compact size of detectable gas generator 400. Pipe connection 418 is designed to direct detectable gas released through output port 416 into pipe system 422.

Detectable gas generator 400 includes battery 420 to provide power to pump 410 and heat exchange 414. Detectable gas generator 400 also includes a user interface system (not shown). The user interface system may be a remote user interface or an attached user interface. Examples of each have been described herein, and one skilled in the art will recognize that a variety of user interface systems may be utilized and remain within the scope and spirit of the present disclosure.

During operation, detectable gas generator 400 may be connected directly to an opening in pipe system 422 using pipe connection 418. Detectable gas generator 400 may be turned to ensure the correct orientation of the components for proper operation or detectable gas generator 400 may be designed to operate in multiple orientations and/or reorient itself to a proper alignment. For an example, a user may need to ensure that input port 406 is directed upward for the proper operation of detectable gas generator 400. As another example, detectable gas generator 400 is designed for gyroscopic correction wherein the components may rotate within housing 402 based upon the weight of battery 420.

For example, a user may select to attach detectable gas generator 400 under a sink located near the suspected leak. In order to attach detectable gas generator 400, the user removes pipe components that connect sink outlet 426 to pipe system 422. The user then connects detectable gas generator to pipe system 422 using pipe connection 418 which may be threaded to match standard under-counter pipes. Once detectable gas generator 400 is attached to pipe system 422 and oriented for operation, the user may start the device using a user interface (not shown). Detectable gas generator 400 will operate to create a detectable gas and direct the gas into pipe system 422. During operation, the user will search for detectable gas in order to locate leak 424.

Some embodiments of the detectable gas generators shown in FIGS. 1-4 may include a cleaning mode that may remove debris and residue may build up over time. The cleaning mode may be a self-cleaning mechanism or an operational mode used to pass water or another fluid through the system to remove debris or residue in the components. For example, during cleaning mode for detectable gas generator 300, heat exchange 330 may remain off while pump 324 pumps distilled water and/or a cleaning fluid through output tube 328, heat exchange 330, and output port 306. In some embodiments of the cleaning mode, output port 306 would not be operatively associated with a pipe system during the cleaning mode.

The invention being thus described, it will be obvious that the same may be varied in many ways. Such variations are not to be regarded as a departure from the spirit and scope of the invention and all such modifications as would be obvious to one skilled in the art are intended to be included within the scope of the system, method, or apparatus described.

What is claimed:

1. An apparatus for leak detection in a pipe system comprising:
a detectable gas generator supported by a housing, wherein said detectable gas generator creates a detectable gas;
a handle connected to said housing;
an automatic shut-off, wherein said automatic shut-off is operable to stop said detectable gas generator based upon a threshold associated with operational characteristics of said apparatus;
a detectable gas output operatively associated with said detectable gas generator;
a gas output tube, wherein said gas output tube directs said detectable gas from said detectable gas output to said pipe system;
a pipe connection, wherein said pipe connection attaches said gas output tube to said pipe system;
at least one of a power source supported by said housing and a power source connector, wherein said power source connector facilitates a removable connection between said detectable gas generator and a power supply; and
a user interface, wherein said user interface is operable to control functions of said detectable gas generator.

2. The apparatus according to claim 1, further comprises ventilation passageways in said housing.

3. The apparatus according to claim 1, wherein said handle is adjustable to at least one position wherein said handle operates to hold said apparatus adjacent to said pipe system.

4. The apparatus according to claim 1, wherein said threshold is at least one of a temperature level, a fluid level, and a time limit.

5. The apparatus according to claim 1, wherein said user interface is wirelessly associated with said detectable gas generator.

6. The apparatus according to claim 1, further comprising a test valve, wherein said test valve is operatively associated with said detectable gas output and is operable to release said detectable gas from said detectable gas output.

7. The apparatus according to claim 1, further comprising an indicator, wherein said indicator communicates a status of operation to a user.

8. The apparatus according to claim 7, wherein said indicator is at least one of a speaker, a light source, gas alteration source, and a mechanical output.

9. The apparatus according to claim 1, further comprising a microcontroller.

10. The apparatus according to claim 1, further comprising a timer, wherein said timer may control the release of detectable gas.

11. An apparatus for leak detection in a pipe system comprising:
a detectable gas generator, wherein said detectable gas generator creates a detectable gas;
a detectable gas output operatively associated with said detectable gas generator;
a pipe connector, wherein said pipe connector attaches said detectable gas output to said pipe system, and said pipe connector supports said detectable gas generator when in operable attachment with said pipe system;
a battery supported by said housing; and
a user interface, wherein said user interface is operable to control functions of said detectable gas generator.

12. The apparatus according to claim 11, comprising an automatic shut-off, wherein said automatic shut-off is operable to stop said detectable gas generator based upon a threshold associated with operational characteristics of said apparatus.

13. The apparatus according to claim 12, wherein said threshold is at least one of a temperature level, a fluid level, and a time limit.

14. The apparatus according to claim 11, wherein said user interface is wirelessly associated with said detectable gas generator.

15. The apparatus according to claim 11, further comprising a orientation system, wherein said orientation system may alter the orientation of said detectable gas generator.

16. A method of detecting a leak in a pipe system comprising:
connecting a detectable gas generator to a pipe system, wherein said detectable gas generator produces a detectable gas, wherein said detectable gas generator comprises an automatic shut-off, wherein said automatic shut-off is operable to stop said detectable gas generator based upon a threshold associated with operational characteristics of said detectable gas generator;
beginning said detectable gas generator, wherein said detectable gas generator directs detectable gas into said pipe system;
locating said detectable gas;
allowing detectable gas to dissipate following a stoppage of production of said detectable gas by said detectable gas generator; and
locating said leak in said pipe system following a restart of production of said detectable gas by said detectable gas generator, wherein locating said leak in said pipe system comprises locating where said detectable gas is released from said pipe system.

17. The method of claim 16, further comprising stopping production of said detectable gas by a remote user interface; and restarting production of said detectable gas by said remote user interface.

18. The method of claim 16, further comprising setting said detectable gas generator to execute said stoppage of production of said detectable gas and said restart of production of said detectable gas on a timed basis.

19. The method of claim 16, further comprising monitoring characteristics of said detectable gas generator on a remote user interface.
